(19) United States
(12) Patent Application Publication
(10) Pub. No.: US 2026/0184649 A1
(43) Pub. Date: Jul. 2, 2026

(54) CULTURE SOIL FOR LEGUMINOUS PLANT, USE OF THE SAME, CULTIVATION SET FOR LEGUMINOUS PLANT, METHOD FOR CULTIVATING LEGUMINOUS PLANT, AND SEEDLING OF LEGUMINOUS PLANT WITH CULTURE SOIL

(71) Applicant: Ibaraki University, Ibaraki (JP)

(72) Inventors: Kazuhiko NARISAWA, Ibaraki, Inashiki-gun (JP); Citra Innosensia NI LUH PUTU, Inashiki-gun, Ibaraki (JP)

(73) Assignee: Ibaraki University, Ibaraki (JP)

(21) Appl. No.: 19/128,575

(22) PCT Filed: Nov. 9, 2023
(86) PCT No.: PCT/JP2023/040453

§ 371 Date: May 9, 2025

(30) Foreign Application Priority Data
Nov. 11, 2022 (JP) 2022-181348

(51) Int. Cl. C05F 11/08; A01G 22/40; A01G 24/20

(52) U.S. Cl. CPC C05F 11/08; A01G 22/40; A01G 24/20

(57) ABSTRACT

Culture soil for a leguminous plant including soil and dark-septate endophyte symbiotic fungus that includes at least one fungus selected from the group consisting of a fungus of the genus Cladophialophora, a fungus of the genus Exophiala, and a fungus of the genus Veronaeopsis, a cultivation set for a leguminous plant using the culture soil, a method for cultivating a leguminous plant, and a seedling of a leguminous plant with culture soil, as well as use of the culture soil for cultivation of a leguminous plant.

### TECHNICAL FIELD

The present disclosure relates to culture soil for a leguminous plant and use thereof, a cultivation set for a leguminous plant, a method for cultivating a leguminous plant, and a seedling of a leguminous plant with culture soil.

### BACKGROUND ART

According to the Food and Agricultural Organization of the United Nations, the agricultural land area where crops can be produced without any problems is about 40% of the total agricultural land area in the world. Currently, approximately 5 million ha of farmland is further deteriorated per year, and it is expected that, in 2050, the arable land per person in the world will decrease to ¼ of the level of the arable land in 1960, unless new efforts are made to secure the farmland. Accordingly, it has become necessary to transition from conventional farming, which prioritizes productivity, to sustainable agriculture, which emphasizes environmental considerations.

In conventional farming, which prioritizes productivity, specific types of crops may be cultivated exclusively on specific farmland. However, continuously cultivating the same crop in the same location may promote the proliferation of certain types of pathogens (e.g., pests or pathogenic bacteria), disrupt the balance of the ecosystem, and adversely affect crop production. This is because many pathogens have host specificity to crops. As a method for solving this problem, cultivation methods utilizing dark-septate endophyte symbiotic fungi are known. Dark-septate endophyte (DSE) symbiotic fungi are useful microorganisms that have a symbiotic relationship with plants by forming mycorrhiza with plants and inhabiting plant roots.

Patent Literature 1 describes the effect of promoting soybean growth in a low-temperature environment by soybean rhizobia belonging to genus Bradyrhizobium.

Patent Literature 2 describes that inoculation with the endophyte Veronaeopsis simplex Y34, K45, or a CBS strain can confer advantageous traits that stabilize the growth of crops.

Patent Literature 3 describes that inoculation with the endophyte Veronaeopsis simplex Y34 strain has an effect of suppressing the absorption of radioactive cesium in tomatoes.

Patent Literature 4 describes that inoculation with the Azospirillum brasilense NI-10 strain and rhizobia has an effect of promoting the growth and increasing the yield of leguminous plants.

Patent Literature 5 describes that inoculation of the endophyte Stenotrophomonas sp. MYK101 strain into leguminous plants has an effect of promoting the growth and increasing the yield of the leguminous plants.

Non-Patent Literature 1 describes a cultivation method in which the fungus Cladophialophora chaetospira SK51 is allowed to establish symbiosis with strawberry seedlings affected by wilt disease induced by a fungus of the genus Fusarium.

### PRIOR ART LITERATURE

### Patent Literature

Patent Literature 1: Japanese Patent Application Laid-Open (JP-A) No. 2021-090395
Patent Literature 2: Japanese Patent Application Laid-Open (JP-A) No. 2021-052740
Patent Literature 3: Japanese Patent Application Laid-Open (JP-A) No. 2016-054711
Patent Literature 4: Japanese Patent Application Laid-Open (JP-A) No. H08-109109
Patent Literature 5: Japanese Patent Application Laid-Open (JP-A) No. 2015-027995

### Non Patent Literature

Non Patent Literature 1: Wiwiek Harsonowati et al., The Effectiveness of a Dark Septate Endophytic Fungus, Cladophialophora chaetospira SK51, to Mitigate Strawberry Fusarium Wilt Disease and With Growth Promotion Activities, Front. Microbiol., 2020. April 15, Vol. 11, Art. 585

### SUMMARY OF INVENTION

### Technical Problem

As described above, various studies have been conducted on promoting plant growth using symbiotic fungi. However, there is a need for further development in techniques for promoting the growth of leguminous plants.

An object of the present disclosure is to provide culture soil for a leguminous plant that is capable of promoting the growth of a leguminous plant, and the use thereof, a cultivation set for a leguminous plant, a method for cultivating a leguminous plant, and a seedling of a leguminous plant with culture soil.

### Solution to Problem

Specific means for solving the above problem include the following aspects.
(1) Culture soil for a leguminous plant, including:
   a dark-septate endophyte symbiotic fungus including at least one fungus selected from the group consisting of a fungus of the genus Cladophialophora, a fungus of the genus Exophiala, and a fungus of the genus Veronaeopsis; and soil.
(2) The culture soil for a leguminous plant according to claim 1, further including rhizobia.
(3) The culture soil for a leguminous plant of a plant according to claim 1, wherein the fungus of the genus Cladophialophora is Cladophialophora chaetospira.
(4) The culture soil for a leguminous plant according to claim 1, wherein the dark-septate endophyte symbiotic fungus is a fungus of the genus Veronaeopsis.
(5) The culture soil for a leguminous plant according to claim 4, wherein the soil has a pH of from 4 to less than 6.
(6) The culture soil for a leguminous plant according to claim 1, wherein the dark-septate endophyte symbiotic fungus is a fungus of the genus Cladophialophora.
(7) The culture soil for a leguminous plant according to claim 6, wherein the soil has a pH of from 6 to 7.
(8) A cultivation set for a leguminous plant, including:
   the culture soil for a leguminous plant according to any one of claims 1 to 7; and
   a leguminous plant.
(9) A method for cultivating a leguminous plant, the method including cultivating a leguminous plant using the culture soil for a leguminous plant according to claim 1.
(10) The method for cultivating a leguminous plant according to claim 9, wherein, in cultivation, the dark-septate endophyte symbiotic fungus and rhizobia are mixed with a plant contemporaneously to cultivate the leguminous plant.
(11) A seedling of a leguminous plant with culture soil, including:
   the culture soil for a leguminous plant according to any one of claims 1 to 7; and
   a seedling of a leguminous plant.
(12) Use of the culture soil for a leguminous plant according to any one of claims 1 to 7 for cultivation of a leguminous plant.

### Advantageous Effects of Invention

The present disclosure provides culture soil for a leguminous plant that is capable of promoting the growth of a leguminous plant, and the use thereof, a cultivation set for a leguminous plant, a method for cultivating a leguminous plant, and a seedling of a leguminous plant with culture soil.

### BRIEF DESCRIPTION OF THE DRAWINGS

FIG. 1A is a photograph showing (A) an overall growth condition of soybean seedlings on Day 14 of cultivation after mixing dark-septate endophyte symbiotic fungi with the soybean seedlings in Examples 1, 2, and 3, and Comparative Example 1.

FIG. 1B is a graph showing (B) the dry mass of the stem-to-leaf region and the root region of the soybean seedlings on Day 14 of cultivation after mixing the dark-septate endophyte symbiotic fungi with the soybean seedlings in Examples 1, 2, and 3, and Comparative Example 1.

FIG. 2 is a graph showing the dry mass of soybeans harvested on Day 140 of cultivation after mixing the dark-septate endophyte symbiotic fungi with the soybean seedlings in Examples 1, 2, and 3, and Comparative Example 1.

FIG. 3 is a photograph showing the state of the root nodules formed on the roots of the plants on Day 40 of cultivation after mixing the dark-septate endophyte symbiotic fungi with the soybean seedlings in Examples 1, 2, and 3, and Comparative Example 1.

FIG. 4 is a graph showing the amount of phosphate absorbed by the soybean plants on Day 0, Day 100, and Day 140 of cultivation after mixing the dark-septate endophyte symbiotic fungi with the soybean seedlings in Examples 1, 2, and 3, and Comparative Example 1.

FIG. 5A is a graph showing (A) the number of leaves in the soybean plants on Day 20 of cultivation after mixing dark-septate endophyte symbiotic fungi with the soybean seedlings in Examples 4, and 5 and Comparative Example 2.

FIG. 5B is a graph showing (B) the dry mass of the soybean plants on Day 20 of cultivation after mixing the dark-septate endophyte symbiotic fungi with the soybean seedlings in Examples 4, and 5 and Comparative Example 2.

FIG. 5C is a photograph showing (C) the growth condition of the seedlings of the soybean plants on Day 20 of cultivation after mixing the dark-septate endophyte symbiotic fungi with the soybean seedlings in Examples 4, and 5 and Comparative Example 2.

FIG. 6A is a graph showing (A) the number of roots of the soybean plants on Day 27 of cultivation in Example 6 and Comparative Example 3.

FIG. 6B is a graph showing (B) the number of leaves of the soybean plants on Day 27 of cultivation in Example 6 and Comparative Example 3.

FIG. 7A is a graph showing (A) the number of roots of the soybean plants on Day 20 of cultivation in Example 7 and Comparative Example 4.

FIG. 7B is a graph showing (B) the number of leaves of the soybean plants on Day 20 of cultivation in Example 7 and Comparative Example 4.

### DESCRIPTION OF EMBODIMENTS

Hereinafter, embodiments of the present disclosure will be described in detail. However, the present disclosure is not limited to the following embodiments. In the following disclosure, the constituent elements (including element steps and the like) are not essential unless otherwise specified. The same applies to numerical values and ranges thereof, and the present disclosure is not limited thereto.

In the present disclosure, the term “step” includes not only a step independent of other steps but also a step that cannot be clearly distinguished from other steps as long as the purpose of the step is achieved.

In the present disclosure, a numerical range described using “to” includes numerical values described before and after “to” as a lower limit value and an upper limit value, respectively.

In the numerical ranges described in a stepwise manner in the present disclosure, the upper limit value or the lower limit value described in one numerical range may be replaced with the upper limit value or the lower limit value of another numerical range described in a stepwise manner. Further, in the numerical ranges described in the present disclosure, the upper limit value or the lower limit value of the numerical ranges may be replaced with a value shown in the Examples.

In the present disclosure, in a case in which multiple kinds of substances corresponding to a component are present in the composition, the content of the component means the total content of the multiple kinds of substances present in the composition unless otherwise specified.

In the present disclosure, even when an element is referred to in a singular form, the presence of multiple elements is not excluded as long as there is no technical contradiction, unless otherwise specified.

### <<Culture Soil for Leguminous Plant>>

Culture soil for a leguminous plant according to the present disclosure includes soil and a dark-septate endophyte symbiotic fungus that includes at least one fungus selected from the group consisting of a fungus of the genus Cladophialophora, a fungus of the genus Exophiala, and a fungus of the genus Veronaeopsis.

The culture soil for a leguminous plant according to the present disclosure can promote the growth of a leguminous plant by having the above configuration. Although the underlying mechanism of action is not entirely clear, it is presumed as follows.

The dark-septate endophyte symbiotic fungus that includes at least one fungus selected from the group consisting of a fungus of the genus Cladophialophora, a fungus of the genus Exophiala, and a fungus of the genus Veronaeopsis contained in the culture soil extends hyphae in a network shape around the roots of a leguminous plant. Then, when the fungus adheres to the surface of the roots of the leguminous plant, it forms appressoria, enters the root cells of the leguminous plant and colonizes them, thereby establishing symbiosis with the leguminous plant.

Once symbiosis is established, amino acids, proteins, or the like, which have not been efficiently used as nutrients by the leguminous plant prior to the symbiosis, can also be more readily supplied to the plant by the fungus. It is believed that this enables the leguminous plant to absorb nutrients such as nitrogen and phosphorus more easily than before the symbiosis, thereby promoting its growth.

In the present disclosure, the promotion of growth can be confirmed by an increase in the dry mass of above-ground parts, such as fruits, leaves, and stems of the cultured leguminous plant, or in the root dry mass of the cultured leguminous plant, as compared to cultivation of the leguminous plant using culture soil that does not contain a dark-septate endophyte symbiotic fungus.

The type of the leguminous plant cultivated in the culture soil for a leguminous plant according to the present disclosure is not particularly limited, and known leguminous plants such as soybeans, peas, broad beans, and adzuki beans can be applied. Among them, the culture soil for a leguminous plant according to the present disclosure is particularly excellent in promoting the growth of soybeans and adzuki beans.

### <Dark-Septate Endophyte Symbiotic Fungus>

The dark-septate endophyte symbiotic fungus includes at least one fungus selected from the group consisting of a fungus of the genus Cladophialophora, a fungus of the genus Exophiala, and a fungus of the genus Veronaeopsis. One type of the dark-septate endophyte symbiotic fungus may be used alone or a combination of two or more types of the dark-septate endophyte symbiotic fungus may be used.

From the viewpoint of further promoting the growth of the leguminous plant, the dark-septate endophyte symbiotic fungus preferably includes at least one of a fungus of the genus Cladophialophora or a fungus of the genus Veronaeopsis, and more preferably includes one of the genus Cladophialophora or a fungus of the genus Veronaeopsis.

A dark-septate endophyte symbiotic fungus is a microorganism having a symbiotic relationship with plants by forming mycorrhiza with plants and inhabiting plant roots.

Examples of the fungus of the genus Cladophialophora include Cladophialophora chaetospira, Cladophialophora arxii, Cladophialophora tortuosa, Cladophialophora floridana, Cladophialophora psammophila, Cladophialophora boppii, Cladophialophora hachijoensis, Cladophialophora carrionii, Cladophialophora tumbae, and Cladophialophora tumulicola. Among the above, the fungus of the genus Cladophialophora is preferably Cladophialophora chaetospira from the viewpoint of further promoting the growth of the leguminous plant. One type of the fungus of the genus Cladophialophora may be used alone or a combination of two or more types of the fungus of the genus Cladophialophora may be used.

As Cladophialophora chaetospira, Cladophialophora chaetospira SK51 (hereinafter, also referred to as SK51 or SK51 strain) deposited under the accession number NITE BP-03539 or a mutant strain thereof is preferred. The SK51 strain has been deposited at the Patent Microorganism Depositary, Biotechnology Center, National Institute of Technology and Evaluation, located at 2-5-8 Kazusa-Kamatari, Kisarazu City, Chiba Prefecture, Japan (accession date: Sep. 28, 2021).

Non-limiting examples of the methods for introducing mutations include methods that use treatment with a chemical agent, such as a nitroso compound (e.g., a nitrosamine or a nitrosoguanidine) or an alkylating agent (e.g., EMS; ethyl methanesulfonate), ultraviolet irradiation, and radiation exposure. Whether or not the obtained mutant strain exhibits an equivalent or greater effect compared to the SK51 strain can be determined by evaluating the growth-promoting effect of the obtained mutant strain on the leguminous plant and comparing it with the result of the effect obtained by the SK51 strain.

Examples of the fungus of the genus Exophiala include known species such as Exophiala pisciphila and mutant strains thereof, and Exophiala sp. SK47. Among the above, from the viewpoint of further promoting the growth of the leguminous plant, the fungus of the genus Exophiala is preferably Exophiala sp. SK47. One type of the fungus of the genus Exophiala may be used alone or a combination of two or more types of the fungus of the genus Exophiala may be used.

Examples of the fungus of the genus Veronaeopsis include Veronaeopsis simplex and mutant strains thereof. Among the above, the fungus of the genus Veronaeopsis is preferably Veronaeopsis simplex from the viewpoint of further promoting the growth of the leguminous plant. One species of the fungus of the genus Veronaeopsis may be used alone or a combination of two or more species of the fungus of the genus Veronaeopsis may be used.

The method for producing the culture soil for a leguminous plant according to the present disclosure is not particularly limited, and a method for producing culture soil containing any known fungus can be applied. The method for producing the culture soil for a leguminous plant according to the present disclosure may involve, for example, mixing a culture material (e.g., a mixture of wheat bran, rice bran, leaf mold, and sterilized water) with a culture solution containing the dark-septate endophyte symbiotic fungus (e.g., 1×10⁵ hyphal fragments/ml to 1×10⁶ hyphal fragments/ml), culturing the mixture (e.g., culturing for 3 weeks to 4 weeks in a chamber), and subsequently further mixing the culture material with soil. Here, the content of the culture material containing the dark-septate endophyte symbiotic fungus with respect to the total amount of the culture soil for a leguminous plant is preferably from 5% by mass to 10% by mass from the viewpoint of further promoting the growth of the leguminous plant.

The total fungal count of the dark-septate endophyte symbiotic fungus is not particularly limited, and is preferably 1×10³ hyphal fragments/g or more with respect to the culture soil for a leguminous plant from the viewpoint of further promoting the growth of the leguminous plant. Since the leguminous plant and the dark-septate endophyte symbiotic fungus are in a symbiotic relationship, the fungal count of the dark-septate endophyte symbiotic fungus in the culture soil increases as the cultivation time of the leguminous plant progresses. The above-described fungal count is the fungal count at the time point when the cultivation of the leguminous plant is initiated in the culture soil for a leguminous plant (e.g., at the time point of seeding the plant in the culture soil, or at the time point of transplanting a previously grown seedling at a trifoliate stage to plant it in the culture soil).

The fungal count of the dark-septate endophyte symbiotic fungus can be measured by plating the fungus on 50% by mass CMMY agar medium and then culturing the fungus at 23° C. for 7 days.

The form in which the dark-septate endophyte symbiotic fungus is present in the culture soil may be any form in a fungal life cycle. The form of the fungus may be, for example, a mycelium or a spore.

The culture soil for a leguminous plant may further contain a dark-septate endophyte symbiotic fungus that is not a fungus of the genus Cladophialophora, a fungus of the genus Exophiala, and a fungus of the genus Veronaeopsis, as long as the effect of the present disclosure is exhibited. Examples of such a dark-septate endophyte symbiotic fungus include Meliniomyces variabilis and Phialocephala fortinii.

The culture soil for a leguminous plant may further contain a microorganism that is not a dark-septate endophyte symbiotic fungus, as long as the effect of the present disclosure is exhibited. Examples of such a microorganism include, in addition to rhizobia described later, Agrobacterium pusense (e.g., Rhizobium sp. Y9), bacteria of the genus Pseudomonas, bacteria of the genus Paenibacillus, bacteria of the genus Stenotrophomonas, and bacteria of the genus Delftia.

### <Soil>

The soil may be, for example, any of organic cultivation soil, conventional cultivation soil (i.e., inorganic cultivation soil), and mixed soil thereof.

The organic cultivation soil refers to soil that contains neither an agricultural chemical nor a chemical fertilizer.

The conventional cultivation soil (i.e., inorganic cultivation soil) refers to soil that contains an agricultural chemical and/or a chemical fertilizer.

The pH of the soil is preferably from 3 to 7 from the viewpoint of further exhibiting the effect of the present disclosure. The pH of the soil may be, for example, from 3 to less than 4, from 4 to less than 6, or from 6 to 7.

The pH of the soil is measured by the following method. The soil and distilled water are mixed at a ratio of 1:2.5 (1:5 in the case of using soil having a high organic matter content), and the mixture is stirred for 1 hour or more with a reciprocating shaker. Then the pH of the suspension is measured at 23° C.±2° C. by a glass electrode method, and the obtained value is defined as the pH of the soil.

For example, when the dark-septate endophyte symbiotic fungus is a fungus of the genus Veronaeopsis, the pH of the soil is preferably from 4 to less than 6 from the viewpoint of further promoting the growth of the leguminous plant.

For example, when the dark-septate endophyte symbiotic fungus is a fungus of the genus Cladophialophora, the pH of the soil is preferably from 6 to 7 from the viewpoint of further promoting the growth of the leguminous plant.

### <Rhizobia>

From the viewpoint of further promoting the growth of the leguminous plant, the culture soil for a leguminous plant preferably further contains rhizobia.

Rhizobia refer to fungi that form root nodules on the roots of a leguminous plant.

In general, leguminous plants form a symbiotic relationship with rhizobia. Rhizobia convert nitrogen in the atmosphere into ammoniacal nitrogen through the root nodules formed on the roots of leguminous plants, and supply the ammoniacal nitrogen to the host leguminous plants, whereby soybeans obtain a nitrogen source. As described above, it has already been known that leguminous plants can form a symbiotic relationship with rhizobia, and it has been believed that the promotion of the growth of leguminous plants by rhizobia is inhibited when other fungi form a symbiotic relationship with rhizobia. On the other hand, the inventors have newly discovered that a dark-septate endophyte symbiotic fungus including at least one fungus selected from the group consisting of a fungus of the genus Cladophialophora, a fungus of the genus Exophiala, and a fungus of the genus Veronaeopsis forms a symbiotic relationship with rhizobia and plants, and do not inhibit but promote the growth of the leguminous plants.

Examples of the rhizobia include bacteria of the genus Bradyrhizobium (e.g., Bradyrhizobium japonicum) and bacteria of the genus Rhizobium. Among the above, the rhizobia are preferably Bradyrhizobium japonicum from the viewpoint of further promoting the growth of the leguminous plant.

### <Other Components>

The culture soil for a leguminous plant may further contain component(s) other than the dark-septate endophyte symbiotic fungus, soil, and rhizobia, as long as the effect of the present disclosure is exhibited. Examples of such other component(s) include a solid medium (e.g., an amino acid such as leucine, methionine, or phenylalanine, or sucrose) and a liquid medium (e.g., water, sterilized water, sterilized distilled water, or physiological saline), a component for stably retaining the fungus in the culture soil (e.g., a stabilizer or a tonicity agent), and a component for promoting proliferation of the fungus according to the present disclosure (e.g., malt extract medium (MEB), CM malt yeast medium (CMMY) (mixture of 8.5 g of CM agar, 15 g of agar, 10 g of malt extract, 1 g of yeast extract, and 1 L of sterilized water), wheat bran, rice bran, or humus).

### <<Cultivation Set for Leguminous Plant>>

The cultivation set according to the present disclosure is a cultivation set for a leguminous plant including the culture soil for a leguminous plant according to the present disclosure and a leguminous plant. According to the present disclosure, the cultivation set for a leguminous plant that promotes the growth of the leguminous plant can be obtained.

Examples of the leguminous plant include a seed and a seedling of a leguminous plant.

A seed of a leguminous plant conceptually includes not only an ungerminated seed but also a seed in which a radicle or plumule has already emerged.

Examples of the seedling of a leguminous plant include a seedling with only cotyledons, a seedling at the trifoliate stage, a seedling beyond the trifoliate stage, a daughter or granddaughter seedling propagated from a parent plant (e.g., a runner seedling), and a clonal seedling propagated through grafting or cuttings, for example.

### <<Method for Cultivating Leguminous Plant>>

The method for cultivating a leguminous plant according to the present disclosure includes cultivating a leguminous plant using the culture soil for a leguminous plant according to the present disclosure (hereinafter, also referred to as “cultivation step”).

According to the present disclosure, it is possible to cultivate a legume with enhanced growth.

In the cultivation step, from the viewpoint of further promoting the growth of the leguminous plant, it is preferable to cultivate the leguminous plant by mixing the dark-septate endophyte symbiotic fungus and rhizobia with the plant contemporaneously. In other words, from the viewpoint of further promoting the growth of the leguminous plant, the culture soil for a leguminous plant according to the present disclosure preferably further contains rhizobia.

The cultivation step may be, for example, a step of growing a leguminous plant from a seed to a seedling using the culture soil for a leguminous plant according to the present disclosure, and then planting the seedling into soil to cultivate the leguminous plant until the harvest time.

The cultivation method is not particularly limited as long as the culture soil for a leguminous plant according to the present disclosure is used. The culture soil for a leguminous plant according to the present disclosure may be used alone for the cultivation, or the culture soil for a leguminous plant according to the present disclosure may be mixed with soil for planting or other culture soil for the cultivation.

In the case of mixing the culture soil for a leguminous plant according to the present disclosure with other soil or other culture soil for cultivation, the timing of the mixing of the culture soil for a leguminous plant according to the present disclosure may be at the time of sowing a seed of the leguminous plant into the soil, at the time of transplanting a seedling at the trifoliate stage into the soil, or at the time of planting the seedling into the soil. Alternatively, a seed of the leguminous plant may be sown, a seedling at the trifoliate stage may be transplanted, or a seedling may be planted, into soil in which the culture soil for a leguminous plant according to the present disclosure has been pre-mixed.

The cultivation conditions may be appropriately designed depending on the soil to be used, the variety of the leguminous plant, climate, and the like.

For example, the cultivation step may involve inducing flower bud formation under a low-temperature and short-day condition, followed by cultivation under a high-temperature and long-day condition.

The low-temperature and short-day condition refers to a temperature range of from more than 5° C. to 15° C., with a photoperiod of from 0 hours to 12 hours.

The high-temperature and long-day condition refers to a temperature range of from more than 15° C. to 25° C. (preferably from more than 20° C. to 25° C., and more preferably 23±1° C.), with a photoperiod from more than 12 hours to 24 hours (preferably from more than 14 hours to 24 hours, and more preferably from 15 hours to 17 hours).

In the cultivation step, for example, the temperature in an artificial climate chamber used for growing the leguminous plant may be kept constant, and the cultivation locations may be rotated every few days, so as to ensure temperature uniformity.

<<Seedling of Leguminous Plant with Culture Soil>>

A seedling of a leguminous plant according to the present disclosure is a seedling of a leguminous plant with culture soil including the culture soil for a leguminous plant according to the present disclosure and a seedling of a leguminous plant. According to the present disclosure, a seedling of a leguminous plant with enhanced growth can be obtained.

### <<Use of Culture Soil for Leguminous Plant>>

According to the present disclosure, by using the culture soil for a leguminous plant according to the present disclosure to cultivate a leguminous plant, the growth of the leguminous plant can be promoted.

### EXAMPLES

Hereinafter, embodiments of the present disclosure will be specifically described with reference to Examples. However, the embodiments of the present disclosure are not limited to these Examples. Unless otherwise specified, “parts” are on a mass basis.

### <<Preparation of Dark-Septate Endophyte Symbiotic Fungi>>

As dark-septate endophyte symbiotic fungi, Cladophialophora chaetospira SK51 (hereinafter also referred to as Cc), which is a fungus of the genus Cladophialophora, Exophiala sp. SK47 (hereinafter also referred to as Esp), which is a fungus of the genus Exophiala, and Veronaeopsis simplex Y34 (hereinafter also referred to as Vs), which is a fungus of the genus Veronaeopsis, were each prepared.

The aforementioned Esp is a fungus deposited under the accession number NITE BP-03540 at the Patent Microorganism Depositary, Biotechnology Center, National Institute of Technology and Evaluation, located at 2-5-8 Kazusa-Kamatari, Kisarazu City, Chiba Prefecture, Japan (accession date: Sep. 28, 2021).

The aforementioned Cc is a fungus deposited under the accession number NITE BP-03539 at the Patent Microorganism Depositary, Biotechnology Center, National Institute of Technology and Evaluation, located at 2-5-8 Kazusa-Kamatari, Kisarazu City, Chiba Prefecture, Japan (accession date: Sep. 28, 2021).

The aforementioned Vs is a fungus deposited under the accession numbers NITE P-01933 and NITE BP-01933 at the Patent Microorganism Depositary, Biotechnology Center, National Institute of Technology and Evaluation, located at 2-5-8 Kazusa-Kamatari, Kisarazu City, Chiba Prefecture, Japan (accession date: Sep. 5, 2014).

The three types of fungi were each cultured in a 500 mL flask containing 250 mL of 2% by mass malt extract medium (MEB) under shaking conditions of 23° C. and 120 rpm for 4 weeks. After the culturing, the three types of mycelia were collected by filtering the culture solution, and were washed with sterile distilled water until the liquid containing the collected mycelia became clear, so that no substances derived from the MEB medium were brought in. Thereafter, the obtained mycelia and sterilized distilled water were mixed at the minimum speed for 1 minute using a mixer and a laminar flow to prevent contamination, thereby obtaining preculture solutions. The viability of each fungus in the preculture solutions was measured by directly plating the preculture solutions containing the mycelia on 50% by mass CMMY agar medium, and then culturing them at 23° C. for 7 days.

The mass production of each fungus was performed by the following method. Specifically, 10 mL of the preculture solution of each of the fungi (1×10⁶ hyphal fragments/ml) was added to a sterilized plastic bag containing a sterilized culture material (mixture of 50 g of wheat bran, 50 g of rice bran, 150 g of humus, and 170 mL of sterilized water). Then, the mixture of the preculture solution of each of the fungi and the culture material was cultured in a chamber for 3 to 4 weeks to prepare materials containing the respective fungi.

### <<Preparation of Soil>>

As an organic cultivation soil, organic soil (manufactured by Sakata Seed Corporation) was prepared.

The prepared organic cultivation soil had a pH of 6.0, and was defined as “neutral organic cultivation soil”. On the other hand, by mixing a suitable amount of peat moss (manufactured by TACHIKAWA HEIWA NOUEN CO., LTD.) with the prepared organic cultivation soil, a “weakly acidic organic cultivation soil” with a pH of 4.0 was prepared.

The pH of the soil was measured by the following method. Specifically, the soil and distilled water were mixed at a ratio of 1:2.5 (1:5 in the case of using soil having a high organic matter content), and the mixture was stirred for 1 hour or more with a reciprocating shaker, and then the pH of the suspension was measured at 23° C.±2° C. by the glass electrode method, thereby obtaining the pH of the soil.

All the above soils were sterilized by pressure 2 times at 121° C. for 30 minutes.

### <<Production of Culture Soil for Leguminous Plant>>

Soil having the pH shown in Table 1, a material containing the species of the dark-septate endophyte symbiotic fungus shown in Table 1, and rhizobia were mixed to obtain the culture soil for a leguminous plant of each of the Examples. The dark-septate endophyte symbiotic fungus was mixed at 10% by mass with respect to the entire culture soil.

TABLE 1

| | | Types of the dark- | |
|---|---|---|---|
| | Soil | septate endophyte | Presence of |
| | pH | symbiotic fungi | rhizobia |
| Comparative Example 1 | 6.0 | — | Yes |
| Example 1 | 6.0 | Esp | Yes |
| Example 2 | 6.0 | Vs | Yes |
| Example 3 | 6.0 | Cc | Yes |
| Comparative Example 2 | 4.0 | — | Yes |
| Example 4 | 4.0 | Vs | Yes |
| Example 5 | 4.0 | Cc | Yes |

### <<Soybean Cultivation: Examples 1 to 5>>

Seeds of soybean to be cultivated were prepared. The surface of the seeds was sterilized by the following method. Specifically, the seeds were immersed in a 70% by mass ethanol solution for 40 seconds, and then immersed in a sodium hypochlorite (1% by mass effective chlorine) solution for 15 seconds. Next, the seeds were washed three times with sterilized distilled water, dried overnight, and then placed on a 1% by mass water agar medium and allowed to stand at 23° C. for 2 days to germinate. Thereafter, the temperature in the artificial climate chamber was maintained at 23° C., and the seedlings were grown until the seedlings reached the trifoliate stage.

In Example 1, seeds of “Fukuyutaka”, which exhibit excellent processing characteristics for products such as tofu, were prepared as the soybean variety for cultivation. In Examples 2 to 5, seeds of “Suzumaru”, which exhibit excellent processing characteristics for products such as natto, were prepared as the soybean variety for cultivation.

In a pot having a diameter of 6 cm, a material containing the species of the dark-septate endophyte symbiotic fungus shown in Table 1, rhizobia, and organic cultivation soil having the pH shown in Table 1 were mixed to obtain a culture soil for a leguminous plant. In this pot, the above-mentioned seedling at trifoliate stage was planted and cultivated at 30° C. for 14 hours in a bright place and at 22° C. for 10 hours in a dark place at a photosynthesis photon flux density (PPFD) of 89.46 m⁻²·s⁻¹ in the artificial climate chamber. During the cultivation, watering was performed once a day.

### <<Cultivation of Soybean: Comparative Examples 1 and 2>>

A culture soil for a leguminous plant was obtained in the same manner as in Example 1 except that the culture soil did not contain a material containing a dark-septate endophyte symbiotic fungus and was organic cultivation soil having the pH shown in Table 1. Then, soybean was cultivated using the same method as in Example 1.

### <<Evaluation>>

### <Growth Condition of Soybean Seedling: Day 14 of Cultivation>

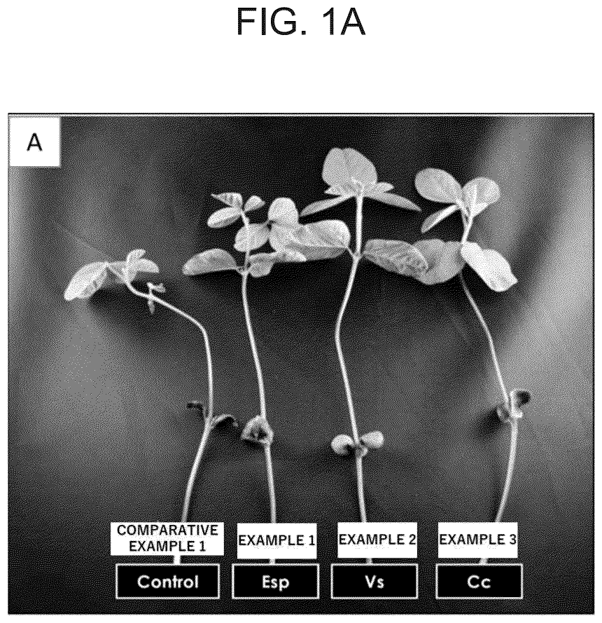

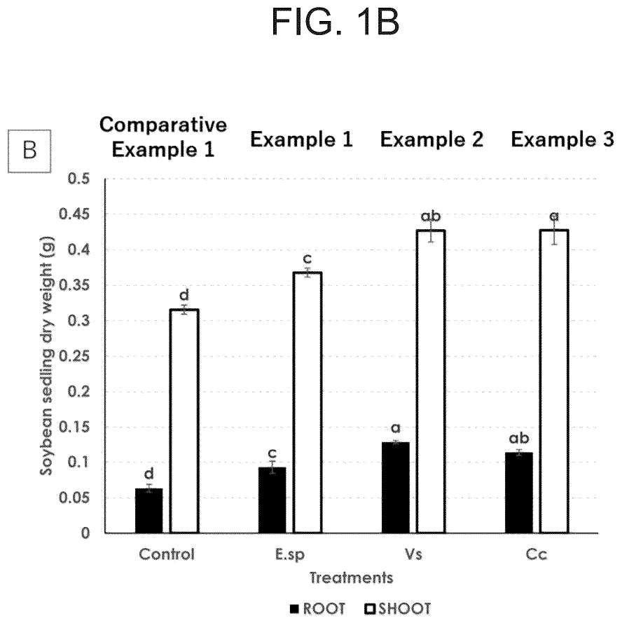

FIG. 1A is a photograph showing (A) an overall growth condition of soybean seedlings on Day 14 of cultivation after mixing the dark-septate endophyte symbiotic fungi with the soybean seedlings in Examples 1, 2, and 3, and Comparative Example 1.

FIG. 1B is a graph showing (B) the dry mass of the stem-to-leaf region and the root region of the soybean seedlings on Day 14 of cultivation after mixing the dark-septate endophyte symbiotic fungi with the soybean seedlings in Examples 1, 2, and 3, and Comparative Example 1.

The dry mass is a value determined by cultivating the soybean seedling in the culture soil for a leguminous plant of each of the Examples, then removing the soybean plant from the pot, separating the soybean plant into a stem-to-leaf region and a root region, drying them at 40° C. for 72 hours, and measuring their mass. Statistical analysis was performed using SPSS version 20.0 (SPSS, IBM, Armonk, NY, United States), conducting one-way analysis of variance (ANOVA) and Tukey's range test (p<0.05).

As shown in FIG. 1A and FIG. 1B, it was found that the soybean seedlings of Examples 1 to 3 in symbiosis with the dark-septate endophyte symbiotic fungi had a significantly increased dry mass in the stem-to-leaf regions of the seedlings as compared with the soybean seedlings of Comparative Example 1 not in symbiosis with any dark-septate endophyte symbiotic fungi, indicating that the growth of the leguminous plant was promoted.

As shown in FIG. 1B, it was found that, among the soybean seedlings of Examples 1 to 3 in symbiosis with the dark-septate endophyte symbiotic fungi, Examples 2 and 3, in which the dark-septate endophyte symbiotic fungi were Vs and Cc, respectively, had a further increase in the dry mass of the stem-to-leaf regions of the seedlings compared with Example 1 in which the dark-septate endophyte symbiotic fungus was Esp, indicating that Examples 2 and 3 were superior in promoting the growth of the soybean, a leguminous plant.

### <Yield of Soybean: Day 140 of Cultivation>

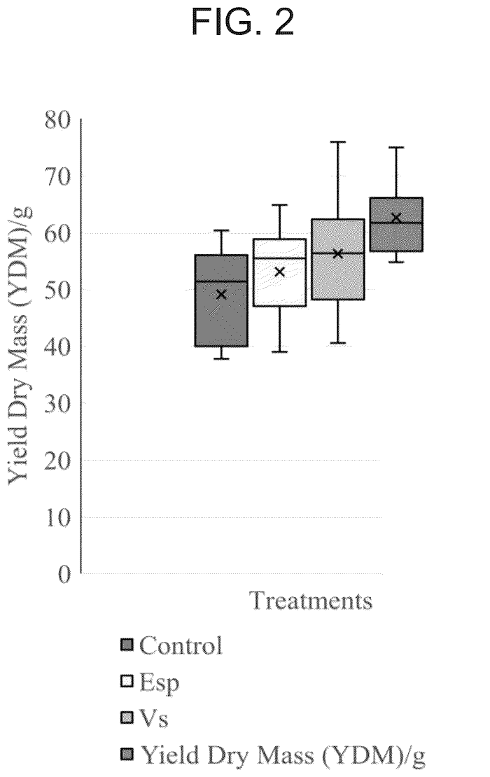

FIG. 2 is a graph showing the dry mass of the soybeans harvested on Day 140 of cultivation after mixing the dark-septate endophyte symbiotic fungi with the soybean seedlings in Examples 1, 2, and 3, and Comparative Example 1. The dry yield of harvested soybeans refers to the dry yield of soybean beans taken out from pods. The dry yield was measured and statistically analyzed in the same manner as in the evaluation of <Growth Condition of Soybean Seedling: Day 14 of Cultivation>.

The symbols “—” in the bar graph of FIG. 2 represent the median (second quartile) of each dataset.

The symbols “x” in the bar graph of FIG. 2 represent the average value of each dataset.

The symbols “*” in the bar graph of FIG. 2 represent data points that were found to be statistically significant based on the results of statistical analysis.

As shown in FIG. 2, it was found that the growth of the soybeans, which are leguminous plants, was promoted, and that the yield was increased in the soybean plants of Examples 1 to 3 in symbiosis with the dark-septate endophyte symbiotic fungi, as compared with the soybean plant of Comparative Example 1 not in symbiosis with any dark-septate endophyte symbiotic fungi.

### <Mass of Root Nodules Formed on Roots of Soybean: Day 40 of Cultivation>

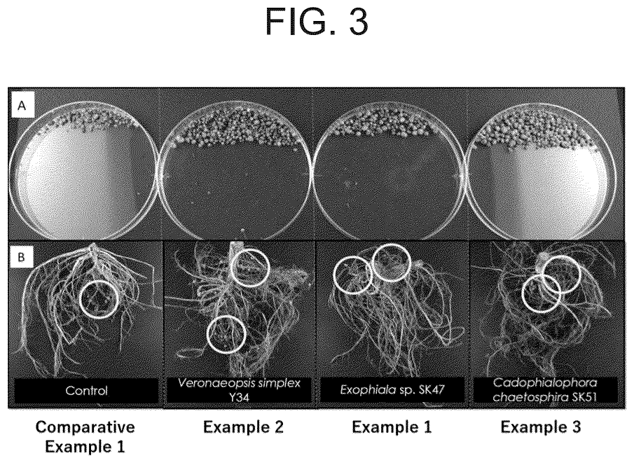

FIG. 3 is a photograph showing the state of the root nodules formed on the roots of the plants on Day 40 of cultivation after mixing the dark-septate endophyte symbiotic fungi with the soybean seedlings in Examples 1, 2, and 3, and Comparative Example 1.

As shown in FIG. 3, it was found that the soybean plants of Examples 1 to 3 in symbiosis with the dark-septate endophyte symbiotic fungi tended to have a greater number of root nodules formed on the roots as compared with the soybean plant of Comparative Example 1 not in symbiosis with any dark-septate endophyte symbiotic fungi. In general, root nodules tend to supply nutrient sources such as nitrogen to roots of leguminous plants. Therefore, the increase in the yield of the soybeans and the growth promotion achieved in the Examples is believed to be partly attributable to the increase in the number of root nodules.

<Measurement of Amount of Phosphate in Soil during Cultivation>

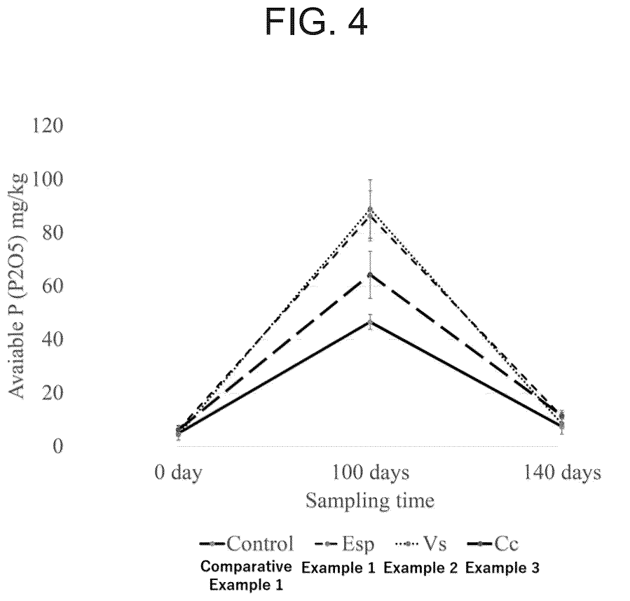

FIG. 4 is a graph showing the amount of phosphate absorbed by the soybean plants on Day 0, Day 100, and Day 140 of cultivation after mixing the dark-septate endophyte symbiotic fungi with the soybean seedlings in Examples 1, 2, and 3, and Comparative Example 1. The amount of phosphate absorption is a value quantified by a spectrophotometer (SPCA-6210, manufactured by Shimadzu Corporation) based on the available phosphate extracted from the soybean seedlings at each cultivation period in accordance with the Bray's Method I. Statistical analysis was performed in the same manner as in the evaluation of

### <Growth Condition of Soybean Seedling: Day 14 of Cultivation>.

As shown in FIG. 4, it was found that the soybean plants of Examples 1 to 3 in symbiosis with the dark-septate endophyte symbiotic fungi tended to have a larger amount of phosphate absorption as compared with the soybean plant of Comparative Example 1 not in symbiosis with any dark-septate endophyte symbiotic fungi. In general, phosphate serves as a nutrient source for leguminous plants, and thus, the increase in the yield of soybeans and the growth promotion achieved in the Examples are believed to be partly attributable to the increase in the amount of phosphate absorption.

<Evaluation of Correlation between Soil pH and Growth Condition of Soybean>

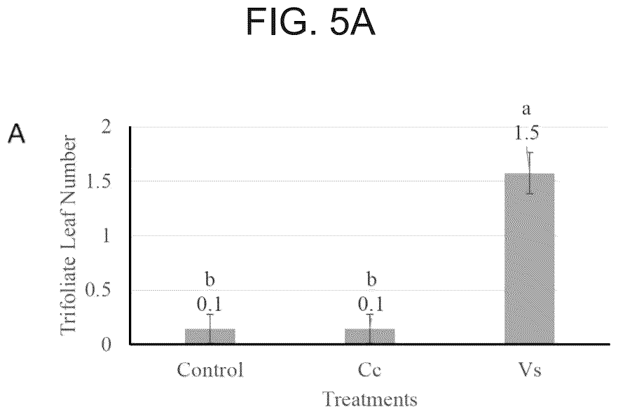

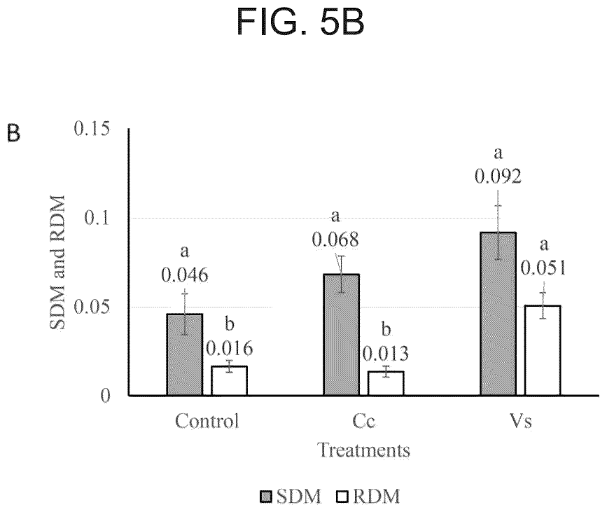

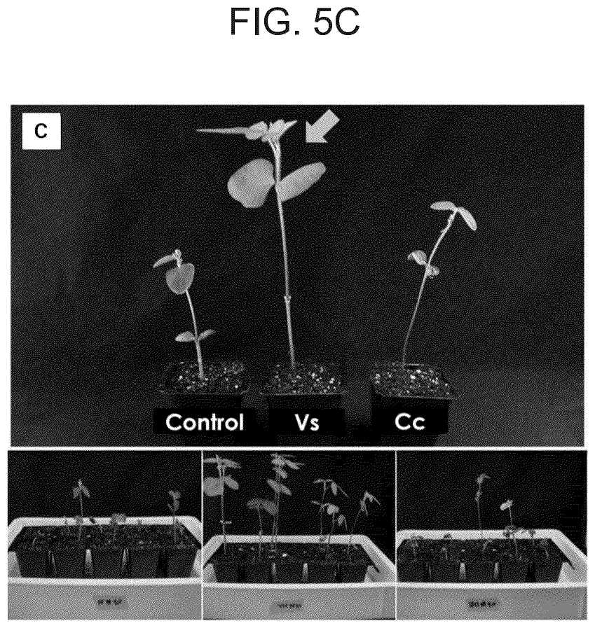

FIG. 5A is a graph showing (A) the number of leaves in the soybean plants on Day 20 of cultivation after mixing the dark-septate endophyte symbiotic fungi with the soybean seedlings in Examples 4, and 5 and Comparative Example 2.

FIG. 5B is a graph showing (B) the dry mass of the soybean plants on Day 20 of cultivation after mixing the dark-septate endophyte symbiotic fungi with the soybean seedlings in Examples 4, and 5 and Comparative Example 2.

FIG. 5C is a photograph showing (C) the growth condition of the seedlings of the soybean plants on Day 20 of cultivation after mixing the dark-septate endophyte symbiotic fungi with the soybean seedlings in Examples 4, and 5 and Comparative Example 2.

In FIG. 5B, “SDM” refers to Shoot Dry Mass (i.e., dry mass of leaves and stems (aerial parts)), and “RDM” refers to Root Dry Mass (i.e., dry mass of roots) (unit: g). The measurement of dry mass and statistical analysis were performed in the same manner as in the evaluation of <Growth Condition of Soybean Seedling: Day 14 of Cultivation>.

As shown in FIGS. 5A to 5C, in the soybean plant of Example 4, in which the dark-septate endophyte symbiotic fungus was Vs, the number of leaves and the dry mass tended to increase as compared with the soybean plant of Example 5, in which the dark-septate endophyte symbiotic fungus was Cc, and the soybean plant of Comparative Example 2 not in symbiosis with any dark-septate endophyte symbiotic fungi. In other words, it was found that the growth of leguminous plants is promoted even in a weakly acidic soil environment of pH4.

### <<Cultivation of Soybean: Example 6>>

Soybean seeds were sterilized using the same material and method as in Example 1.

Thereafter, the seeds were placed in a culture soil for a leguminous plant containing a dark-septate endophyte symbiotic fungus of the type shown in Table 2, and allowed to stand at 23° C. for 7 days in the artificial climate chamber to germinate and grow.

Thereafter, on Day 7 of cultivation, the seedlings were planted and cultivated at 30° C. for 14 hours in a bright place and at 22° C. for 10 hours in a dark place using a culture soil containing rhizobia at a photosynthesis photon flux density (PPFD) of 89.46 m⁻²·s⁻¹ in the artificial climate chamber. During the cultivation, watering was performed once a day.

### <<Cultivation of Soybean: Comparative Example 3>>

Soybeans were cultivated in the same manner as in Example 6 except that the culture soil for a leguminous plant containing the dark-septate endophyte symbiotic fungus was changed to a culture soil not containing any dark-septate endophyte symbiotic fungi.

### <<Cultivation of Soybean: Example 7>>

The surface of soybean seeds was sterilized using the same material and method as in Example 1.

Thereafter, the seeds were placed in a culture soil for a leguminous plant containing rhizobia and a dark-septate endophyte symbiotic fungus of the type shown in Table 2, and allowed to stand at 23° C. for 7 days in the artificial climate chamber to germinate and grow.

Thereafter, on Day 4 of cultivation, the seedlings were planted and cultivated at 30° C. for 14 hours in a bright place and at 22° C. for 10 hours in a dark place at a photosynthesis photon flux density (PPFD) of 89.46 m⁻²·s⁻¹ in the artificial climate chamber. During the cultivation, watering was performed once a day.

### <<Cultivation of Soybean: Comparative Example 4>>

Soybeans were cultivated in the same manner as in Example 7 except that the culture soil for a leguminous plant containing the dark-septate endophyte symbiotic fungus and rhizobia was changed to a culture soil that contained only rhizobia and did not contain any dark-septate endophyte symbiotic fungi.

TABLE 2

| | | Types of the dark- | | |
|---|---|---|---|---|
| | | septate endophyte | Presence of | |
| | Soil pH | symbiotic fungi | rhizobia | Characteristics |
| Comparative | 6.0 | — | Yes | Culture soil containing a dark-septate |
| Example 3 | | | | endophyte symbiotic fungus was not |
| | | | | mixed on Day 0 of cultivation, and |
| | | | | culture soil containing rhizobia was |
| | | | | mixed when planting a seedling on Day |
| | | | | 7 of cultivation. |
| Example 6 | 6.0 | Cc | Yes | Culture soil containing the dark-septate |
| | | | | endophyte symbiotic fungus was mixed |
| | | | | on Day 0 of cultivation, and culture soil |
| | | | | containing rhizobia was further mixed |
| | | | | when planting a seedling on Day 7 of |
| | | | | cultivation. |
| Comparative | 6.0 | — | Yes | Culture soil containing only rhizobia |
| Example 4 | | | | was mixed on Day 0 of cultivation, and |
| | | | | a seedling was planted as it is on Day 4 |
| | | | | of cultivation. |
| Example 7 | 6.0 | Cc | Yes | Culture soil containing the dark-septate |
| | | | | endophyte symbiotic fungus and |
| | | | | rhizobia was mixed on Day 0 of |
| | | | | cultivation, and seedling was planted as |
| | | | | it is on Day 4 of cultivation. |

### <<Evaluation>>

### <Evaluation of Timing of Blending of Rhizobia and Dark-Septate Endophyte

### Symbiotic Fungus>

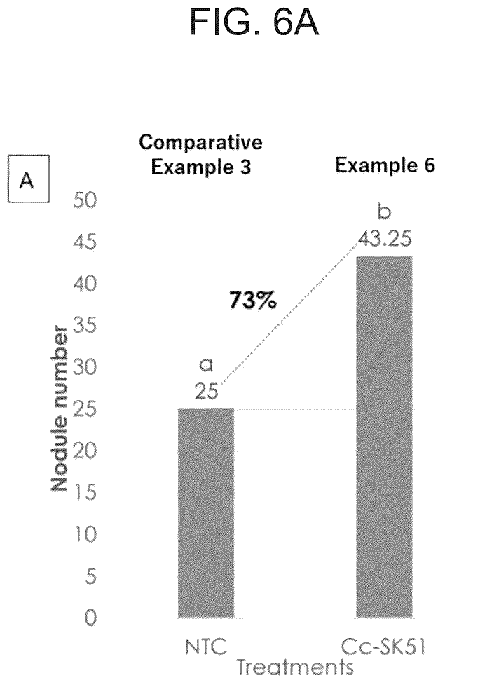

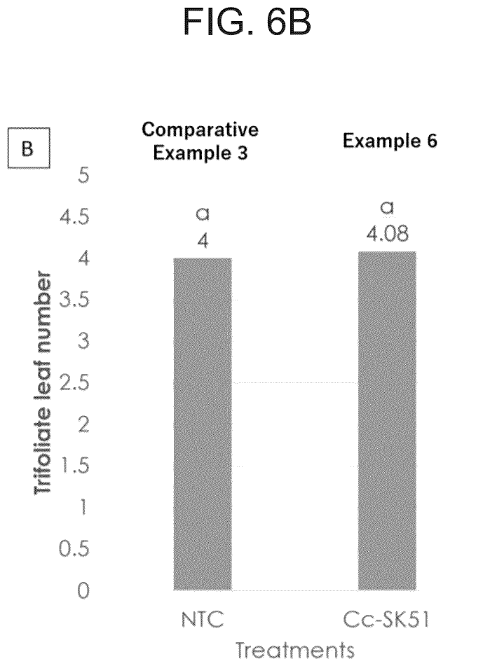

FIG. 6A is a graph showing (A) the number of roots of the soybean plants on Day 27 of cultivation in Example 6 and Comparative Example 3.

FIG. 6B is a graph showing (B) the number of leaves of the soybean plants on Day 27 of cultivation in Example 6 and Comparative Example 3.

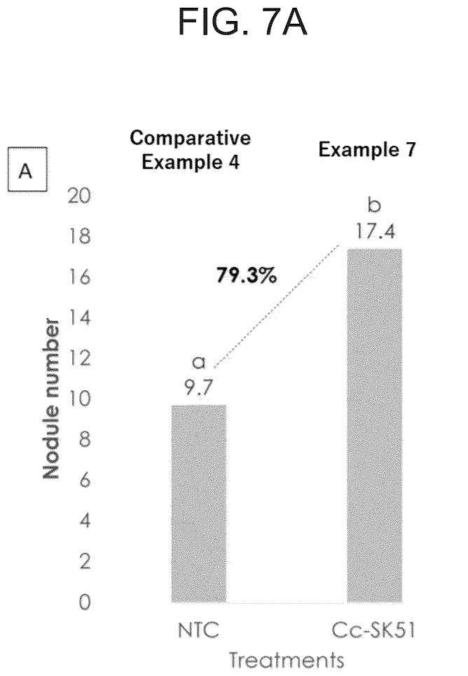

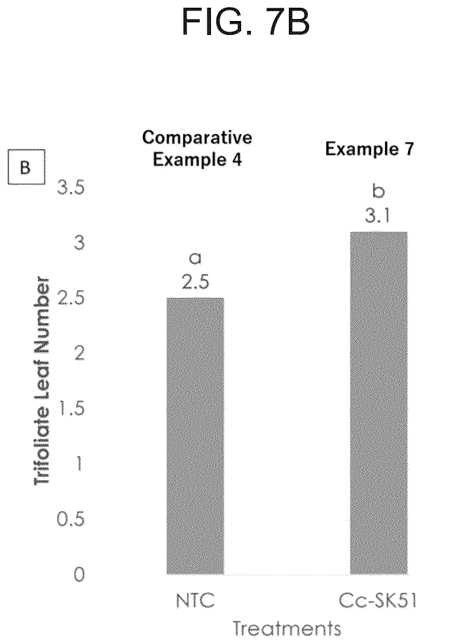

FIG. 7A is a graph showing (A) the number of roots of the soybean plants on Day 20 of cultivation in Example 7 and Comparative Example 4.

FIG. 7B is a graph showing (B) the number of leaves of the soybean plants on Day 20 of cultivation in Example 7 and Comparative Example 4.

As shown in FIGS. 6A and 6B and FIGS. 7A and 7B, it was found that the culture soils for a leguminous plant of the Examples promote the growth of soybeans, which are leguminous plants, as compared with the culture soils for a leguminous plant of the Comparative Examples, regardless of the timing of mixing the culture soils for a leguminous plant containing the dark-septate endophyte symbiotic fungi with the soybean plants.

Furthermore, as shown in FIGS. 6A and 7A, it was found that mixing the symbiotic fungi and rhizobia with the seeds with the same cultivation period (i.e., at a contemporaneous timing) led to enhanced promotion of the growth of soybeans, which are leguminous plants.

The present disclosure of Japanese Patent Application No. 2022-181348 filed on Nov. 11, 2022, is incorporated herein by reference in its entirety. All documents, patent applications, and technical standards described in the present description are incorporated herein by reference to the same extent as if each document, patent application, and technical standard were specifically and individually indicated to be incorporated by reference.

1. Culture soil for a leguminous plant, comprising:
a dark-septate endophyte symbiotic fungus comprising at least one fungus selected from the group consisting of a fungus of the genus Cladophialophora, a fungus of the genus Exophiala, and a fungus of the genus Veronaeopsis;
soil; and
rhizobia.

2. (canceled)

3. The culture soil for a leguminous plant according to claim 1, wherein the fungus of the genus Cladophialophora is Cladophialophora chaetospira.

4. The culture soil for a leguminous plant according to claim 1, wherein the dark-septate endophyte symbiotic fungus is a fungus of the genus Veronaeopsis.

5. The culture soil for a leguminous plant according to claim 4, wherein the soil has a pH of from 4 to less than 6.

6. The culture soil for a leguminous plant according to claim 1, wherein the dark-septate endophyte symbiotic fungus is a fungus of the genus Cladophialophora.

7. The culture soil for a leguminous plant according to claim 6, wherein the soil has a pH of from 6 to 7.

8. A cultivation set for a leguminous plant, comprising:
the culture soil for a leguminous plant according to claim 1; and
a leguminous plant.

9. A method for cultivating a leguminous plant, the method comprising cultivating a leguminous plant using the culture soil for a leguminous plant according to claim 1.

10. (canceled)

11. A seedling of a leguminous plant with culture soil, comprising:
the culture soil for a leguminous plant according to claim 1; and
a seedling of a leguminous plant.

12. (canceled)

13. The culture soil for a leguminous plant according to claim 1, wherein the culture soil for a leguminous plant has a pH of from 4 to less than 6 when the dark-septate endophyte symbiotic fungus is the fungus of the genus Veronaeopsis.

14. The culture soil for a leguminous plant according to claim 1, wherein the dark-septate endophyte symbiotic fungus is selected from the group consisting of Cladophialophora chaetospira SK51, Exophiala sp. SK47, and Veronaeopsis simplex Y34.

15. The culture soil for a leguminous plant according to claim 1, wherein the leguminous plant is soybeans.

16. The culture soil for a leguminous plant according to claim 1, wherein:
the dark-septate endophyte symbiotic fungus is the fungus of the genus Cladophialophora,
and the culture soil for a leguminous plant has a pH of from 6 to 7;
the dark-septate endophyte symbiotic fungus is the fungus of the genus Exophiala, and the culture soil for a leguminous plant has a pH of from 6 to 7; or
the dark-septate endophyte symbiotic fungus is the fungus of the genus Veronaeopsis, and the culture soil for a leguminous plant has a pH of from 4 to less than 6.
